(19) United States
(12) Patent Application Publication
(10) Pub. No.: US 2011/0212250 A1
(43) Pub. Date: Sep. 1, 2011

(54) LOW-CHOLESTEROL SHRIMP AND METHOD OF OBTAINING SAME

(76) Inventors: Inocencio HIGUERA-CIAPARA, Hermosillo (MX); Alma Rosa Toledo-Guillén, Hermosillo (MX); Lorena Olivia Noriega-Orozco, Guaymas (MX); Karla Guadalupe Martínez-Robinson, Hermosillo (MX)

(21) Appl. No.: 13/037,924

(22) Filed: Mar. 1, 2011

Related U.S. Application Data
(63) Continuation-in-part of application No. 10/525,435, filed on Feb. 22, 2005, now abandoned.

(51) Int. Cl. A23L 1/33; A23B 4/037

(52) U.S. Cl. 426/643; 426/385

(57) ABSTRACT

A low-cholesterol whole shrimp a method of obtaining same includes providing a plurality of peeled and deheaded shrimps processed from original frozen storage. The shrimp is subjected to a freeze drying process to realize dehydrated shrimp that avoids denaturation thereof and with a humidity content of approximately 1 to 10%. Cholesterol is then extracted from the dehydrated shrimp via a stream of a supercritical solvent selective to lipids. The whole shrimp is rehydrated in a vacuum chamber with water, in preparation for cooking with steam.

### PRIORITY STATEMENT

This application is a continuation-in-part of and claims the benefit under 35 U.S.C. §120 of U.S. patent application Ser. No. 10/525,435, filed Feb. 22, 2005 to the inventors and entitled “LOW-CHOLESTEROL SHRIMP AND METHOD OF OBTAINING SAME”, pending, the entire contents of which is hereby incorporated by reference herein.

### BACKGROUND

1. Field

Example embodiments relate generally to whole low-cholesterol shrimp and a method of obtaining same by supercritical fluid extraction (SFE) with supercritical carbon dioxide, which can be marketed for human consumption.

2. Related Art

Research has shown that dietary cholesterol constitutes a significant risk factor in the development of heart disease (Grundy et al., 1982), thus resulting in a need to reduce the cholesterol content in proteinic foods. A low-cholesterol shrimp would be a high value-added product for the shrimp fishery and farming industries, while at the same time meeting the rising demand for low-cholesterol foods. There is considerable interest in reducing the cholesterol content of foods for marketing purposes (Hardardottir and Kinsella, 1988).

Among various industrial techniques used for reducing the cholesterol content of foods, one process known as supercritical extraction has found various commercial applications. This process relies on the use of a supercritical fluid, e.g. a fluid heated above its critical temperature and compressed above its critical pressure. In the supercritical state, the physicochemical differences between the liquid and the gaseous phases disappear; thus the fluid can no longer be liquefied with an increment in pressure thus becoming denser (Sihvonen et al., 1999).

In a supercritical state, a fluid has very peculiar thermodynamic and transport properties. Its density is relatively high, similar to that of a liquid which provides high solvent capacity while its low viscosity and high diffusivity, similar to those of a gas, provide a large penetration capacity within the sample.

Due to all these properties, the speed for solute mass transfer is larger within a supercritical fluid than within a liquid (Rizvi et al., 1986). By manipulating the operating conditions the supercritical fluid has the ability to selectively extract one or more specific components, such as fats, oils, cholesterol, ketones, aldehydes and esters while leaving proteins, sugars, and other carbohydrates practically untouched (Dziezak, 1986).

The most widely-used supercritical solvent in the food industry today is carbon dioxide. This is because carbon dioxide possesses overwhelming advantages over other compounds. It is non-flammable, non-corrosive, non-toxic and non-pollutant. Carbon dioxide is also rather inexpensive, and its critical temperature is also low (31.1° C.). This makes it quite adequate for the extraction of thermally-unstable materials.

The fundamental principles for supercritical fluid extraction (SFE) technology were recognized by Hannay and Hogarth more than 100 years ago, in 1879 (Yamaguchi et al., 1986). However, very few processes based on supercritical extraction have been implemented in the food industry with the aim of reducing the fat and cholesterol content of foods from animal origin. According to a review by Clarke (1997), the application of supercritical fluid extraction (SFE) in fresh meat products has had little success in cholesterol reduction. A few successful cases have been achieved with ground beef.

Cully et al. (1991) (see German Patent Application No. DE-39-29-551-A1 to Cully and Cully's U.S. Pat. No. 5,061,505, hereafter the “'505 patent”) describe SFE methodologies with the use of adsorption solids agents. The '505 patent describes the use of powdered egg yolk and/or with butterfat and also with other homogenized or ground foods. However, there is no mention of whole foods.

Applications of SFE technology to seafood are more limited (Yamaguchi et al., 1986). Hardardottir and Kinsella (1988) carried out successful lipid and cholesterol in ground trout muscle. However, the solubility of muscle proteins was reduced due to the extraction. The protein preparations had poor emulsifying properties and did not form gels. These authors did not experiment with whole trout pieces either, merely ground trout.

It is believed no process has been proposed for the industrial production of shrimp with a reduced content of cholesterol applying SFE or any other type of processing. Yamaguchi et al. (1986), in his experimental work used a krill species (similar to shrimp but much smaller in size) which was previously ground. However, the shrimp market to a large extent is based on the marketing of whole headless shrimp (shrimp tails). Additionally, in the results obtained with krill, Yamaguchi et al. reported cholesterol as one of the minor extraction components. The krill meat deteriorated due to oxidation or depolymerization.

However, in the case of commercial whole shrimp, the shrimp cannot be ground or milled, due to the fact that such grinding reduces the commercial value of the shrimp. Moreover, special care must be taken to avoid protein denaturation of the shrimp tissue. This is because denaturation implies the release of asthaxanthin and thus the formation of caroteno-protein complexes having blue, green or light purple colorations which adversely affects the market value of the shrimp.

Shrimp tissue is constituted by proteins which are distributed along the body of the shrimp. The organoleptic properties of the shrimp meals depend on the chemical composition of the shrimp tissue, which is mainly constituted by lipid, water and protein content.

The shrimp proteins include sarcoplasmic, stomals and myofibrils. The myofibril proteins are associated with the quality of fish and crustacean meals. In particular, the contractile myofibril proteins are related to the texture of the shrimp tissue. Moreover, the texture of the shrimp tissue is related to the integrity of the myosin molecule.

It has been found that these myofibril proteins can become degraded during freezing, cooking and conservation of shrimp. Myofibril proteins in crustaceans exhibit changes during processing and resolution of rigor mortis, as well as during extended storage under freezing. These changes have a deleterious effect in the texture of the marine organisms.

During the denaturation of the proteins, the tissue loses part of its structure before reaching the hydrolysis of the proteins. Denaturation takes place with the formation of ice crystals. These ice crystals naturally bind to the proteins, then the water content of the protein decreases and the proteins become unstable, which leads to a redistribution of the hydrogen bridges and hydrophobic linkages of the proteins, which are originally part of the native structure.

The high temperatures reached during boiling of shrimp also affect the texture of the shrimp tissue. During cooking, a phenomena called “muscle gelation” can occur which provides the shrimp tissue with a sticky texture. The formation of this texture due to muscle gelation is unacceptable to consumers.

McLachlan, et al. (1990), EP-0 356 165, (hereafter the “'165 patent”) discloses a process for the extraction of sterols and lipidic components (for example, cholesterol and fat) from high-protein foodstuffs (specifically meat, pork and chicken) using fluids in a subcritical and supercritical state. The method in the '165 patent involves an initial treatment of the product to remove only the “free water”, but not the total bound water. Thus, the process yields an intermediate-moisture product.

The removal of moisture is carried out through freeze-drying until the moisture level is within a range of 25-60% of the original water content. In another embodiment, freeze drying food flakes can reduce this range to a final water content from 30-55%, and further to 30-40%. Supercritical carbon dioxide was used in the '165 patent for the removal of lipids, immediately separating the fraction of carbon dioxide-fat using a selective adsorbent. The product is later reconstituted using water and fat. The '165 patent recognizes that the physical properties of the reconstituted over dried foodstuff are adversely affected.

Due to the fact that the supercritical extraction is conducted under high levels of humidity (greater than 10%), the cholesterol removal described in the '165 patent to McLachlan, et al. is limited. In addition, the '165 patent is silent about a treatment in animal tissues maintaining an original shape, as the '165 patent is focused on using food chunks as samples and specifically included an initial size reduction.

### SUMMARY

An example embodiment is directed to a method for obtaining a low-cholesterol whole shrimp. The method includes providing a plurality of peeled and deheaded whole shrimp. The whole shrimp is subjected to a freeze drying process freeze dry the shrimp to a humidity content of approximately 1 to 10%. This is to realize dehydrated shrimp and may be done by first freezing the peeled, deheaded whole shrimp at a temperature of −40° C. and a period of 4 hours, and then running the following set of conditions once a vacuum of 0.1 mm Hg is reached:

| Temperature | | | |
|---|---|---|---|
| (° C.) | Time | | |
| −29 | 1 | hr | |
| 0 | 1 | hr | |
| 50 | 4-5 | hr | at a vacuum no higher than 0.2 mmHg |
| 35 | 15-20 | hr | until the shrimp reach a maximum |
| | | | temperature of 5 to 10° C. |
| 25 | 1-3 | hr | until the internal shrimp temperature |
| | | | equals the shrimp surface temperature |

Cholesterol may then be extracted from the dehydrated shrimp by means of a stream of a supercritical solvent of CO₂, at a temperature between 35-39° C., at a pressure between 275-345 bar, and a supercritical solvent volume between 1875-3200 L. The dehydrated shrimp may then be rehydrated in a vacuum chamber with water in a relationship of about 1-10 mL per g shrimp at vacuum and room temperature for about 1-5 hours. The whole rehydrated shrimp may then be cooked with steam at around 100° C., 760 mmHg.

Accordingly, another example embodiment is directed to a low-cholesterol shrimp obtained by the aforementioned method above.

Another example embodiment is directed to a method for obtaining a low-cholesterol whole shrimp. A plurality of peeled and deheaded whole shrimp is provided, and then subjected to a freeze drying process to dehydrate the whole shrimp to a humidity content of approximately 1 to 10%. Freeze drying includes freezing the peeled, deheaded whole shrimp at a temperature of −40° C. and a period of 4 hours, and running other conditions to dehydrate the shrimp once a vacuum of 0.1 mm Hg is reached, with running including holding the shrimp at no higher than 35° C. a minimum of 15 consecutive hours to prevent denaturation of the shrimp. Cholesterol may then be extracted from the dehydrated shrimp. The dehydrated shrimp may then be rehydrated in a vacuum chamber with water.

### BRIEF DESCRIPTION OF THE DRAWINGS

Example embodiments will become more fully understood from the detailed description given herein below and the accompanying drawings, wherein like elements are represented by like reference numerals, which are given by way of illustration only and thus are not limitative of the example embodiments of.

FIG. 1 is a bar chart of sample results from test subjects evaluating characteristics of the shrimp product according to the example embodiment.

FIG. 2 is a surface response graph to illustrate the effect of supercritical extraction operating conditions on the remaining shrimp cholesterol content.

FIG. 3 shows the amount of remaining cholesterol in the shrimp as a function of temperature at different volumes of carbon dioxide and a first constant pressure.

FIG. 4 shows the amount of remaining cholesterol in the shrimp as a function of temperature at different volumes of carbon dioxide and a second constant pressure.

### DETAILED DESCRIPTION

Shrimp, known by different common names throughout the world, are high-cholesterol foods (Oliveira and Silva, et al., 1997). The example embodiments refer to a low-cholesterol shrimp obtained from any of the species from the Subgenus Litopenaeus (i.e., L. occidentalis, L. schmitti, L. setiferus, L. stylirostris, L. vannamei). The process described hereafter is also applicable to other genus, subgenus and species of non-grounded shrimp and to their different sizes, i.e. U-10, U-12, U-15, 16-20, 21-25, 26-30, 31-35, 31/40, 36-40, 41-50, 51-60, 61-70, 71-80 and over 80. Peeled, headless whole shrimp is used as raw material. A natural variability in the content of cholesterol is present among the different shrimp species. However, the process described hereafter will work equally well with only minor adjustments in the processing variables, particularly the volume of supercritical fluid used and temperature of extraction.

As to be described in detail hereafter, the example methodology and shrimp product remove cholesterol from whole (un-milled or ungrounded) shrimp in a way not previously foreseen to retain the market value of the shrimp. As previously explained, shrimp tissue is sensitive; as such it is more delicate than that of pork, beef and/or chicken. As a consequence, shrimp tissue denatures more easily as compared to that of pork, chicken or beef, while its overall market value is affected by the organoleptic properties of the tissue. i.e., as more of the shrimp become denatured, its overall market value falls farther than that of chicken, pork or beef.

Accordingly, the supercritical extraction of shrimp according to the example embodiments should be performed under sufficiently mild enough conditions to prevent damage the tissue and thus denaturation of the shrimp, but at sufficiently robust conditions in order to remove a substantial amount of cholesterol.

As to be detailed fully hereafter in accordance with the example embodiments, in the case of whole shrimp, shrimp is dried at least between 1-10%, preferably at least to 5% of the original water content, and cholesterol supercritical extraction is conducted under softer conditions (as compared to those used for beef, chicken or pork chunks) in order to prevent denaturation of the shrimp tissue.

While differing from the related art discussed above and cited herein, including those of Hasegawa et al. (1984), McLachlan et al. (1990, 1991a, 1991b, 1992) and Cully et al. (1991), and in spite of the fact that cholesterol extraction from the intact muscle presents significant technical difficulties due to the fibrous nature of the muscle itself, in the production of shrimp with reduced cholesterol according to the example embodiments to be described hereafter, a process was developed which maintains the original size of the food in order to keep the geometric appearance of the final product, thus respecting its original shape to satisfy the demand of the consumer.

For this reason also, different shrimp species and sizes having high consumer acceptance due to their flavor and shape were included. This situation posed additional problems such as a higher cholesterol content compared to alternate species and a relatively higher size which makes cholesterol removal more difficult.

In the related art presented by McLachlan, et al. (1990, 1991a, 1991b, 1992) several cholesterol extraction procedures for foods have been described, including stages of dehydration, cholesterol removal using SFE and product reconstitution. However, the methodologies and specific operating conditions differ from the example embodiments detailed hereafter, not the least because these related art methodologies are not applicable to shrimp tissues since these are comprised of shorter muscle fibers which allow faster and easier cooking procedures, as compared with the foods reported in the referenced works. Further, shrimp proteins are subject to a quicker deterioration due to their sensitivity to high or low temperatures, chemical agents, physical abuse, etc. and thus require a significantly more careful handling during processing.

In the related art previously mentioned, several methodologies or specific cholesterol SFE operating conditions and product reconstitution procedures are followed which are not applicable to whole shrimp or to shrimp tissue, since these procedures require more careful handling during processing. Shrimp protein (myosin) is more sensitive to denaturation (freezing, dehydration, cooking) as compared to that of beef, pork or poultry (warm-blooded animals). Moreover, the molecular characteristics of shrimp make it more susceptible to deterioration due to the action of proteolytic enzymes as compared to the collagen found in higher animals (Crawford, 1981).

Accordingly, the example embodiments described hereafter provide a low-cholesterol whole shrimp and process to obtain the low-cholesterol whole shrimp by a supercritical fluid extraction. In general, the process includes a rehydration step which renders a shrimp having suitable sensorial properties which maintain its suitable nutritional properties; namely, a shrimp with a low level of fat and a high level of protein. The process additionally includes a freeze drying step which helps to preserve the shrimp structure as it is subject to a structurally detrimental supercritical fluid extraction (SFE). The example process steps described hereafter prevent denaturation of the shrimp and maintain the texture and organoleptic features of the shrimp.

In general according to the example embodiments, a method to obtain a low-cholesterol whole shrimp includes a step of dehydrating the shrimp and subjecting it to supercritical extraction using a supercritical fluid until the cholesterol content is reduced to a desirable concentration. Thereafter, the shrimp is rehydrated and cooked. Of note, if the steps are conducted under “rush” conditions, the final product would a shrimp dust but not the whole shrimp. Thus, the example methodology processes shrimp under “soft conditions”, in order to be able to prevent the denaturation of the shrimp.

An early step of the methodology involves a dehydration or freeze drying step for the whole shrimp (peeled and deheaded). This step is aimed at promoting the establishment of intramuscular channels in the food matrix to facilitate the subsequent extraction of cholesterol by allowing the proper circulation of the extracting fluid throughout the tissues. On the other hand, due to the highly perishable nature of shrimp, reduction of its moisture content allows a significant reduction of the spoilage rate during its processing and storage.

In this freeze drying step, the shrimp moisture content is lowered to a range of 1-10% of its original moisture content. As will be seen in the inventors' example, this is done under a set of softer operating conditions (time and temperature) that cannot be rushed in order to prevent denaturation of the shrimp. This significantly departs from the to 60% final water content established in the methodology of the '165 patent by McLachlan et al., where the free water is removed and only part of the bound water in the food is removed to obtain an intermediate moisture product.

Processing shrimp with a water content of 25% or more as evidenced in the '165 patent would result in a non-acceptable product (denatured shrimp). During the development of the example methodology—in which the final water content is reduced to 1-10%—twenty freeze-drying experimental trials were performed which took from 12-72 hours, under different operating conditions until a set of conditions were established to provide a desired low water content and at the same time prevent the denaturation of shrimp proteins (this would liberate astaxanthin, the natural muscle pigment in shrimp and form caroteno-protein complexes that give blue, greenish or purple discolorations indicating cooking).

As described in the '165 patent, an intermediate moisture product avoids adverse effects on the sensory evaluation properties of the final product, which is common in foods subjected to severe dehydration procedures resulting in a water content of less than 15%. In the example embodiments, the final water content of the shrimp is between 1-10%, but this low-water content condition did not result in rejection by a trained sensory evaluation panel once the shrimp was reconstituted. This occurred because the cholesterol extraction was performed according to example methodology, with subsequent reconstitution and storage steps able to maintain all aspects of sensory quality at a very high level.

During shrimp reconstitution, applying the traditional methodology for shrimp rehydration (which consists in immersing shrimp in an excess quantity of water at room temperature for a period of time) (Moorjani and Dani, 1968), it was not possible to attain an acceptable rehydration index. A mechanically-assisted rehydration process such as that suggested by McLachlan et al. (1990) might be adequate for ground beef, but is unacceptable for whole shrimp since it would undergo considerable damage to the tissue. Due to the above reasons, several methodologies were devised for rehydrating the shrimp and achieving an adequate rehydration index.

All of these rehydration procedures were evaluated through sensory tests performed on the rehydrated and cooked shrimp. Different cooking procedures were also tested (immersion in boiling water, microwave cooking, steam cooking) until a minimal effect on the sensory properties of shrimp was obtained. The methodology described herein allows the proper rehydration of shrimp with the additional advantage that only water is used for the operation. That is, no polyphosphates, seasoning agents or other ingredients are required to obtain an acceptable product.

In spite of the fact that a procedure for cholesterol extraction from foods has been reported previously, which comprises the stages of dehydration, cholesterol removal by supercritical extraction and product reconstitution, the methodology and operating conditions differ significantly from those reported here and do not apply to shrimp due to its particular geometry, configuration and muscle structure. The processes described in the related art are not applicable to whole pieces of shrimp. Shrimp tissue, as is well known, contains more sensitive proteins to deterioration as compared to the tissue of other types of meat.

By applying the process proposed in the example embodiments, a new product can be obtained, i.e. low-cholesterol shrimp, which has acceptable sensory properties while keeping its nutritional content practically unchanged, i.e. a low fat content (1% or less) and a high protein content (15-20%).

For obtaining the low-cholesterol whole shrimp of the example embodiments, frozen peeled deheaded shrimp are used. The method includes the aforementioned initial dehydration step. The dehydrated shrimp immediately pass to the next processing step which consists of supercritical extraction of cholesterol using a highly selective supercritical solvent (volume between about 1875 to 3200 L) for lipids at a nominal pressure and temperature. For this purpose, supercritical extraction equipment with carbon dioxide as the supercritical fluid is utilized. The dehydrated shrimp are placed in the equipment extraction unit and carbon dioxide is compressed above its critical pressure (100-400 bar). The resulting gas enters the extraction unit supplied with a heating jacket to allow the extraction temperature to be maintained in a range from 30-60° C. and pass through the sample to remove the cholesterol. This process can be applied to any shrimp species and sizes with slight variations in the operating conditions. The discharge gas containing the extract is then passed through an expansion valve. At this point the extract is released from the gas by precipitation since a pressure differential under supercritical conditions implies a decrease in density and a lowering of the solvating capacity.

Dehydrated shrimp containing lower cholesterol content are thus obtained and reconstituted with water using a ratio of 1 to 10 mL per gram of shrimp. Rehydration is carried out by placing shrimp in a vacuum chamber at room temperature for a period of 1-5 hours. The dehydrated shrimp is steam-cooked (about 100° C./760 mm Hg) before presentation to the final consumer in its original shape.

The final product obtained through this process is a low-cholesterol whole shrimp, which is believed by the inventors to be a non-existent commercial product to date. Additionally, this product complies with all the nutritional labeling requirements established for low and reduced-cholesterol products by the Food and Drug Administration. According to such requirements, a cholesterol-reduced product must contain 75% or less cholesterol than the original food from which it is obtained, and for a low-cholesterol product it must contain from 2 to 20 mg of cholesterol per serving (FDA, 1986). A standard error of 20% is allowable in these levels and therefore a cholesterol content of less than 24 mg per serving is acceptable for low cholesterol foods (FDA, 1990).

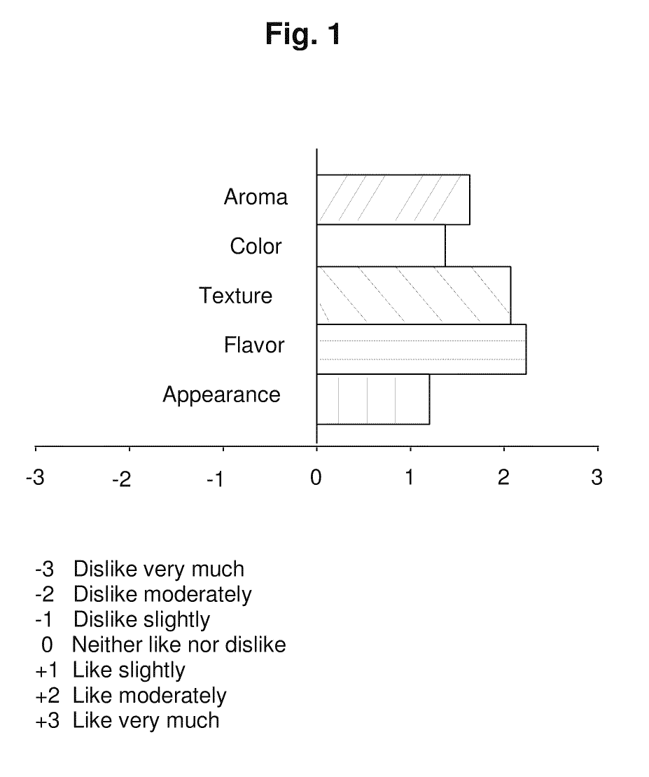

FIG. 1 is a bar chart of sample results from test subjects evaluating characteristics of the shrimp product according to the example embodiment. The final form of the example shrimp product comprises whole pieces of shrimp, not chunks, dices or powder, as has been the case with other products conventionally processed by supercritical extraction. Also, the shrimp continues to possess its original sensory characteristics in terms of texture, flavor, color and overall appearance. A sensory test was performed to evaluate each of these attributes on dehydrated and supercritically-extracted shrimp after rehydration and cooking. Such shrimp corresponded to the category of low-cholesterol shrimp (less than 24 mg of cholesterol per serving). The test was applied to a panel of 30 untrained subjects each of whom evaluated sample color, odor, and overall appearance.

Referring to FIG. 1, the evaluation score was on a scale from −3 (dislike very much) to +3 (like very much). For a statistical analysis a non-parametric Kolmogorov-Smirnov test was performed. All attributes evaluated had a positive score from the panel members and no significant differences were evident in the acceptance scale. As shown in FIG. 1, attributes such as the texture and flavor attributes had a moderate acceptance score (+2) while smell, color and overall appearance gave a slight acceptance score (+1). In relation to smell and taste, several panelists observed that a favorable condition had been caused by the supercritical extraction process since it diminished the typically-strong smell of the product. These results show promising perspectives for the overall acceptance of low-cholesterol shrimp by the end consumer.

The following example is used to illustrate the utility of the example embodiments, without intending to limit the scope thereof.

### Example

The raw material used was in this example was “blue shrimp” (Litopenaeus stylirostris) and “white shrimp” (Litopenaeus vannamei), 16-20 count per pound and deheaded, which were kept under frozen storage (−18° C.) until processed.

Shrimp were thawed, peeled and individually refrozen at −40° C. for a period of 4 hours using a quick freezing system. The shrimp were then freeze-dried until a final water content of 1-5% was reached. The temperature on the product's surface as well as that inside was carefully monitored using thermocouples. When the equipment reached a 0.1 mm Hg vacuum the following program of conditions were followed:

| Temperature (° C.) | Time (hrs) |
|---|---|
| −29 | 1 |
| 0 | 1 |
| 50 | 4-5 ^{a} |
| 35 | 15-20 ^{b} |
| 25 | 1-3 ^{c} |

^{a} The time depends on the level of vacuum achieved, which should not exceed 0.2 mm Hg.
^{b} The time depends on when the shrimp reach a maximum temperature of 5 to 10° C.
^{c} Depending on when the internal shrimp temperature becomes the same as the shrimp surface temperature.

Once the freeze drying process is completed, the shrimp are ready for the extraction of cholesterol.

Cholesterol extraction is carried out in a supercritical extractor using a selective solvent (carbon dioxide) under supercritical conditions of 310 bar and 37° C. For this purpose supercritical extraction equipment with carbon dioxide is used. The extraction system consists of four basic components: a compressor or solvent pump, an extractor, a control system for pressure and temperature and a separator.

Once the shrimp have been placed within the extraction vessel the carbon dioxide is allowed to flow from the storage tank and through the compressor in order to attain the supercritical pressure of 310 bar. The resulting gas enters the extraction chamber containing a heated jacket which allows the operating temperature to be maintained at 37° C. Upon contact of carbon dioxide with the shrimp sample, a process of selective extraction begins and the gaseous carbon dioxide picks up the free cholesterol in the shrimp tissue and produces a cholesterol-rich extract. Both the volume of carbon dioxide and the flow speed are measured carefully. The flow speed should be maintained at 5.5-6.2 L/min but other flow velocities can also be used. After the super extraction step, cholesterol is separated from the carbon dioxide by means of an expansion valve.

The super extraction step concludes when 1875 L of supercritical carbon dioxide are introduced in the system. The spent carbon dioxide can be recycled to the system. Once the supercritical extraction process is completed, the shrimp are subjected to rehydration using water at room temperature in a relationship of 5 mL of water per gram of shrimp. This process should take place under vacuum (533 mm Hg) for at least one hour. At the end of this period, the shrimp is turned on its side and allowed to rehydrate under the same conditions for one more hour.

Upon rehydration, shrimp can be steam-cooked and later packaged in plastic containers under vacuum and quickly-frozen at −40° C. The final product obtained with this process conditions complies with the requirements set forth by FDA for low cholesterol food products.

Experimental Design

A Surface Response Methodology was followed during the course of experimentation with the aim of determining the optimal conditions for cholesterol removal from shrimp by supercritical extraction. A compounded-central rotatory design was applied for three independent variables with five levels for each one. The number of experimental points in the design was sufficient to prove the statistical validity of the quadratic model obtained (Arteaga et al., 1994). The variables used in the stage of cholesterol extraction were: Pressure (X1), Volume (X2) and Temperature (X3). The minimum and maximum levels of the variables were fixed according to results obtained in preliminary experiments. The response variable (Y) was the amount of cholesterol remaining in the final product (dry weight basis) as determined by Gas Chromatography.

Table I shows the average values of the remaining cholesterol content in the end product and the corresponding extraction index (%).

TABLE I

| | | | | Y | CHOLESTEROL | |
|---|---|---|---|---|---|---|
| | X1 | X2 | X3 | CHOLESTEROL | (mg per | |
| | P | V | T | (mg/100 g) | serving) | EXTRACTION |
| TREATMENT | (bar) | (LCO₂) | (° C.) | dry basis | wet basis | % |
| 1 | 289 | 909 | 36 | 225.10 | 52.25 | 61.99 |
| 2 | 331 | 909 | 36 | 292.71 | 67.95 | 50.56 |
| 3 | 289 | 2841 | 36 | 151.41 | 35.15 | 74.43 |
| 4 | 331 | 2841 | 36 | 81.96 | 19.26 | 85.99 |
| 5 | 289 | 909 | 38 | 224.88 | 52.20 | 62.02 |
| 6 | 331 | 909 | 38 | 211.06 | 49.00 | 64.35 |
| 7 | 289 | 2841 | 38 | 72.19 | 16.76 | 87.81 |
| 8 | 331 | 2841 | 38 | 52.02 | 12.08 | 91.21 |
| 9 | 275 | 1875 | 37 | 114.25 | 26.52 | 80.70 |
| 10 | 345 | 1875 | 37 | 99.23 | 23.03 | 83.24 |
| 11 | 310 | 250 | 37 | 366.61 | 85.11 | 38.08 |
| 12 | 310 | 3500 | 37 | 62.14 | 14.43 | 89.50 |
| 13 | 310 | 1875 | 35 | 125.44 | 29.12 | 78.81 |
| 14 | 310 | 1875 | 39 | 97.25 | 22.58 | 83.57 |
| 15 | 310 | 1875 | 37 | 99.68 | 23.14 | 83.16 |

In order to generate an equation that forecasts the effects of operating conditions (X1, X2, X3) on the cholesterol quantity remaining in the final product, a regression program was run. By multiple regression analysis a quadratic model was adjusted and a final regression equation calculated:

Y=6065.3575−0.608833 P+0.1424819 V−303.0457 T+0.0147289 P2-0.000884 VP+0.0000475 V2−0.191346 TP−0.003532TV+4.7773254 T2, where:

Y=Remaining cholesterol in final shrimp product (mg/100 g) Dry Weight Basis

P=Supercritical extraction pressure (bar)

V=Carbon dioxide volume (L)

T=Supercritical extraction temperature (° C.).

The results from the Analysis of Variance for the quadratic model of prediction are presented in Table II wherein a significant effect of the adjusted model (p≦0.05) is evident. Also, the lack of fit resulted non-significant (p>0.05). This information supports the validity of the model.

TABLE II

| SOURCE OF | | SUM OF | MEAN | | | |
|---|---|---|---|---|---|---|
| VARIATION | DF | SQUARES | SQUARE | F-Ratio | p | R² |
| Regression | 9 | 121477.4 | 13497.49 | 18.31 | 0.000202 | 0.953705 |
| Linear effect | 3 | 94030.26 | 31343.42 | 42.52 | 0.000029 | 0.738221 |
| Quadratic | 3 | 24653.4 | 8217.8 | 11.15 | 0.003140 | 0.193551 |
| effect | | | | | | |
| Interactions | 3 | 2793.743 | 931.2475 | 1.26 | 0.350317 | 0.021933 |
| Total error | 8 | 5896.731 | 737.0914 | | | 0.046295 |
| Lack of fit | 5 | 5288.337 | 1057.667 | 5.22 | 0.102269 | 0.041518 |
| Pure error | 3 | 608.3936 | 202.7978 | | | 0.004776 |

According to the Analysis of Variance, some linear and quadratic effects were significant (p≦0.05) for the supercritical extraction process from shrimp, with the most important quadratic effect being that of volume.

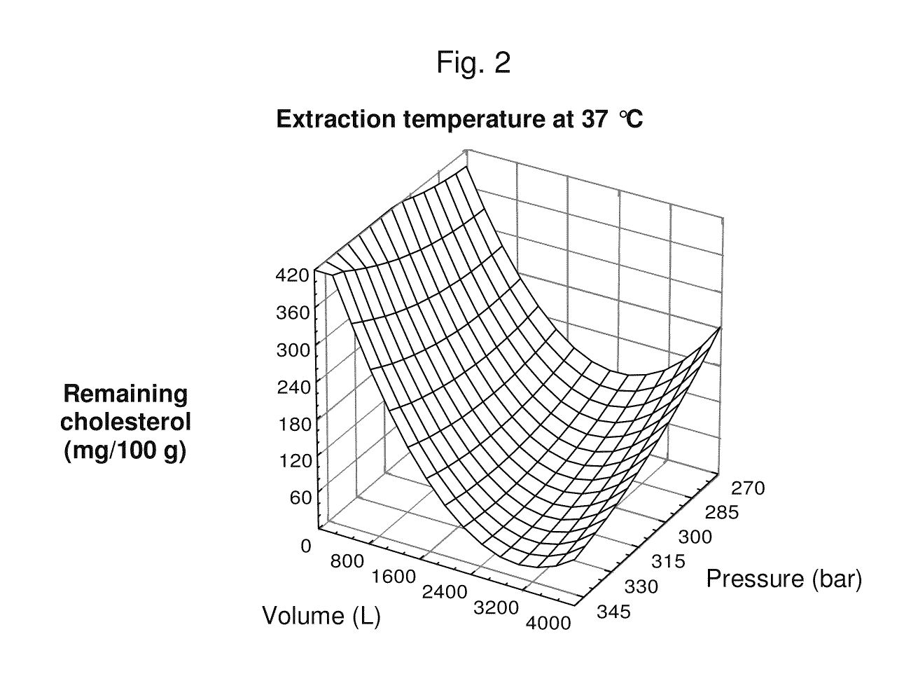

FIG. 2 shows a Surface Response graph which illustrates the final regression equation obtained through this experimentation. The effect of supercritical extraction operating conditions on the remaining shrimp cholesterol content on a dry weight basis highlights the effect of different solvent volumes required, according to the final cholesterol content desired.

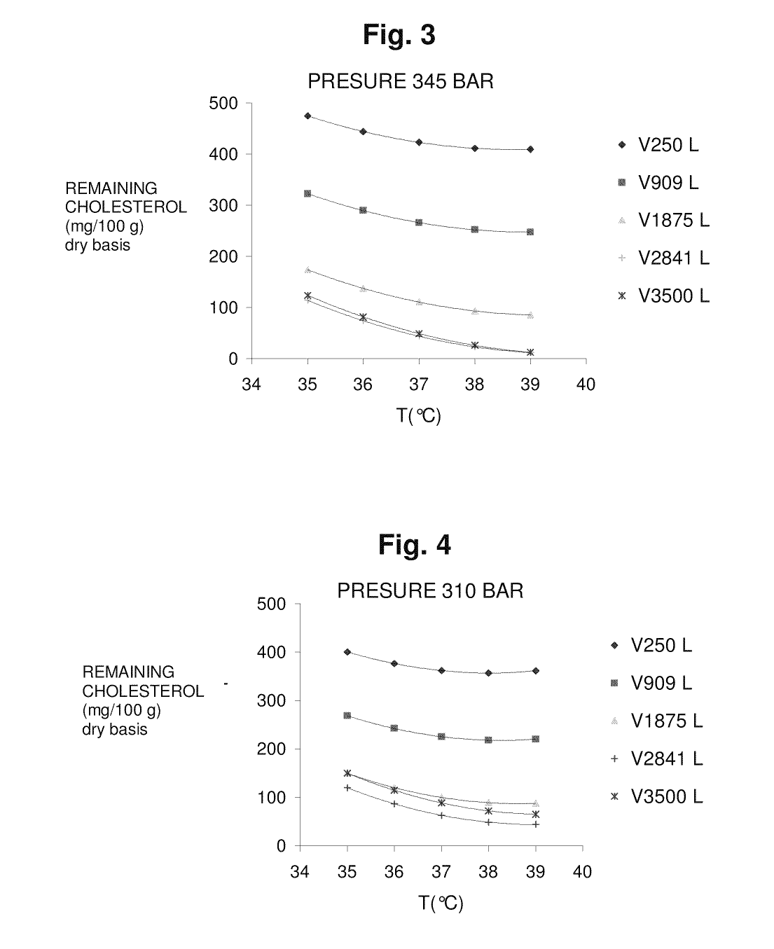

FIG. 3 shows the amount of remaining cholesterol in the shrimp (on a dry weight basis) as a function of temperature at different volumes of carbon dioxide and a pressure of 345 bar. It can be observed that at such pressure the quantity of remaining cholesterol decreases with an increase in the volume of carbon dioxide with respect to temperature. In a supercritical fluid, the effect of temperature on solubility is quite complex due to two concurrent effects. One effect tends to increase solubility with an increase in temperature, while the other tends to decrease it. As the temperature increases, the solute vapor pressure also increases and this increases solubility.

On the other hand, density decreases and this tends to decrease solubility. In this experimental region density is less sensitive to temperature changes and the vapor pressure is the dominant factor so that increases in temperature increase solubility. The temperature at which a minimum of cholesterol content remains is 39° C. (11.77 mg/100 g, dry weight basis). Nevertheless the remaining amount of cholesterol (100 mg per 100 g of shrimp, on a dry weight basis) is sufficient to achieve the FDA requirements for a low-cholesterol food product once it has been rehydrated and cooked, i.e. less than 24 mg cholesterol per 100 g shrimp serving on a wet basis.

FIG. 4 shows the amount of remaining cholesterol in the shrimp as a function of temperature at different volumes of carbon dioxide and a second constant pressure (310 bar). From FIG. 4 it can be observed that with the conditions given in the example the residual cholesterol content attained is 100 mg per 100 g of shrimp on a dry weight basis.

FIGS. 3 and 4 illustrate that with different combinations of operating conditions during supercritical extraction, the same result can be achieved. The conditions given are less drastic so that their adverse effects on the sensory properties of the final low-cholesterol shrimp product are significantly decreased.

Thus, the low-cholesterol whole shrimp described hereinabove contains less cholesterol than its natural counterpart, which is considered a high cholesterol food according to the requirements set forth by the Food and Drug Administration for reduced-cholesterol products (75% or less cholesterol than the natural product), and low-cholesterol (less than 24 mg of cholesterol per 100 g shrimp serving on a wet basis). Additionally, the low-cholesterol whole shrimp is adequate for human consumption, with the same nutritional properties as the natural product, i.e., a protein content from 15 to 25% and a fat content of less than 1%; a mineral content of 1-3% and a moisture content of 50-80%, which possesses sensory and overall sensory properties acceptable to the consumer.

Further, the example shrimp described herein is a ready-to-eat product as well as a flavor enhancer or its use in salads or other prepared dishes, and is not affected in its high protein and low fat content, while presenting sensory properties acceptable to the final consumer.

The example embodiments being thus described, it will be obvious that the same may be varied in many ways. Such variations are not to be regarded as departure from the spirit and scope of the example embodiments, and all such modifications as would be obvious to one skilled in the art are intended to be included within the scope of the following claims.

What is claimed:

1. A method for obtaining a low-cholesterol whole shrimp, comprising:
providing a plurality of peeled and deheaded whole shrimp;
freeze drying the whole shrimp to a humidity content of approximately 1 to 10% to realize dehydrated shrimp by:
freezing the peeled, deheaded whole shrimp at a temperature of −40° C. and a period of 4 hours,
running the following set of conditions once a vacuum of 0.1 mm Hg is reached:

| Temperature | | | |
|---|---|---|---|
| (° C.) | Time | | |
| −29 | 1 | hr | |
| 0 | 1 | hr | |
| 50 | 4-5 | hr | at a vacuum no higher than 0.2 mmHg |
| 35 | 15-20 | hr | until the shrimp reach a maximum |
| | | | temperature of 5 to 10° C. |
| 25 | 1-3 | hr | until the internal shrimp temperature |
| | | | equals the shrimp surface temperature |

extracting cholesterol from the dehydrated shrimp by means of a stream of a supercritical solvent of CO₂, at a temperature between 35-39° C., at a pressure between 275-345 bar, and a supercritical solvent volume between 1875-3200 L;
rehydrating the dehydrated shrimp in a vacuum chamber with water in a relationship of about 1-10 mL per g shrimp at vacuum and room temperature for about 1-5 hours; and
cooking the whole rehydrated shrimp with steam at around 100° C., 760 mmHg.

2. The method of claim 1, wherein the shrimp are selected from a size group comprising: U-10, U-12, U-15, 16-20, 21-25, 26-30, 31-35, 31/40, 36-40, 41-50, 51-60, 61-70, 71-80 and over 80.

3. The method of claim 1, wherein the shrimp are of a size 16/20.

4. The method of claim 1, wherein the shrimp are dehydrated to a humidity content between 1 to 5%.

5. The method of claim 1, wherein the supercritical solvent of CO₂ is at 310 bar pressure and 37° C. temperature.

6. The method of claim 1, wherein the shrimp are rehydrated under a vacuum at least of 533.4 mm Hg.

7. The method of claim 1, wherein the provided plurality of peeled and deheaded whole shrimp are kept under frozen storage as frozen deheaded shrimp prior to processing including thawing and peeling.

8. A low-cholesterol whole shrimp obtained by the method of claim 1.

9. A method for obtaining a low-cholesterol whole shrimp, comprising:
providing a plurality of peeled and deheaded whole shrimp;
freeze drying the whole shrimp to a humidity content of approximately 1 to 10% to realize dehydrated shrimp by:
freezing the peeled, deheaded whole shrimp at a temperature of −40° C. and a period of 4 hours,
running other conditions to dehydrate the shrimp once a vacuum of 0.1 mm Hg is reached, said running including holding the shrimp at no higher than 35° C. a minimum of 15 consecutive hours to prevent denaturation of the shrimp,
extracting cholesterol from the dehydrated shrimp by means of a stream of a supercritical solvent of CO₂, and
rehydrating the dehydrated shrimp in a vacuum chamber with water.

10. The method of claim 9, wherein running other conditions includes holding temperature of the frozen shrimp at 25° C. or greater for at least 20 consecutive hours to prevent denaturation and realize dehydrated shrimp.

11. The method of claim 9, wherein running other conditions further includes maintaining temperature of the frozen shrimp between 25° C. to no higher than 50° C. for a duration between 20 to 28 consecutive hours to prevent denaturation and realize dehydrated shrimp.
